(19) United States
(12) Patent Application Publication
(10) Pub. No.: US 2010/0266283 A1
(43) Pub. Date: Oct. 21, 2010

(54) WDM PON WITH DISTRIBUTION VIA CYCLIC ARRAY WAVEGUIDE GRATING

(75) Inventor: Douglas James BECKETT, Kanata (CA)

Correspondence Address: KED & ASSOCIATES, LLP, P.O. Box 221200, Chantilly, VA, 20153-1200, US

(73) Assignee: LG-Nortel Co. Ltd., Seoul (KR)

(21) Appl. No.: 12/427,355

(22) Filed: Apr. 21, 2009

(51) Int. Cl. H04J 14/00; H04N 7/22

(52) U.S. Cl. 398/68; 348/E07.094

(57) ABSTRACT

In a Wavelength Division Multiplexed Passive Optical Network (WDM-PON) including, a system for distributing uplink, downlink and RF/Video broadcast signalling. An Array Waveguide Grating (AWG) couples respective wavelength channels between a trunk fibre of the WDM-PON and a plurality of branch fibers of the WDM-PON. The AWG has a predetermined free spectral range and implements a channel plan comprising at least three spectral segments, each segment having a width equal to the free spectral range of the AWG. An Optical Line Terminal of the WDM-PON receives wavelength division multiplexed uplink signals within a first one of the spectral segments, and transmits wavelength division multiplexed downlink signals within a second one of the spectral segments. Respective channel plans within the first and second spectral segments are identical. An RF/Video broadcast transmitter generates an RF/Video broadcast signal within a third one of the spectral segments.

### CROSS-REFERENCE TO RELATED APPLICATIONS

This is the first patent application filed in respect of the present invention.

### FIELD OF THE INVENTION

The present application relates generally to Wavelength Division Multiplexed Passive Optical Networks (WDM PON) and, more specifically, to a WDM PON With Distribution Via Cyclic Array Waveguide Grating.

### BACKGROUND OF THE INVENTION

A passive optical network (PON) is a point-to-multipoint network architecture in which unpowered optical splitters are used to enable a single optical fibre to serve multiple premises. A PON typically includes an Optical Line Terminal (OLT) at the service provider's central office connected to a number (typically 32-128) of Optical Network Terminals (ONTs), each of which provides an interface to customer equipment.

In operation, downstream signals are broadcast from the OLT to the ONTs on a shared fibre network. Various techniques, such as encryption, can be used to ensure that each ONT can only receive signals that are addressed to it. Upstream signals are transmitted from each ONT to the OLT, using a multiple access protocol, such as time division multiple access (TDMA), to prevent “collisions”.

A Wavelength Division Multiplexing PON, or WDM-PON, is a type of passive optical network in which multiple optical wavelengths are used to increase the upstream and/or downstream bandwidth available to end users. FIG. 1 is a block diagram illustrating a typical WDM-PON system. As may be seen in FIG. 1, the OLT 4 comprises a plurality of transceivers 6, each of which includes a light source 8 and a detector 10 for sending and receiving optical signals on respective wavelength channels, and an optical combiner/splitter 12 for combining light from/to the light source 8 and detector 10 onto a single optical fibre 14. The light source 8 may be a conventional laser diode such as, for example, a distributed feed-back (DFB) laser, for transmitting data on the desired wavelength using either direct laser modulation, or an external modulator (not shown) as desired. The detector 10 may, for example, be a PIN diode for detecting optical signal received through the network. An optical mux/demux 16 (such as, for example, a Thin-Film Filter—TFF) is used to couple light between each transceiver 6 and an optical fibre trunk 18, which may include one or more passive optical power splitters (not shown).

A passive remote node 20 serving one or more customer sites includes an optical mux/demux 22 for demultiplexing wavelength channels ( [symbol] 1 . . . [symbol] n) from the optical trunk fibre 18. Each wavelength channel is then routed to an appropriate branch port 24 which supports a respective WDM-PON branch 26 comprising one or more Optical Network Terminals (ONTs) 28 at respective customer premises. Typically, each ONT 28 includes a light source 30, detector 32 and combiner/splitter 34, all of which are typically configured and operate in a manner mirroring that of the corresponding transceiver 6 in the OLT 4.

Typically, the wavelength channels ( [symbol] 1 . . . [symbol] n) of the WDM-PON are divided into respective channel groups, or bands, each of which is designated for signalling in a given direction. For example, C-band (e.g. 1530-1565 nm) channels may be allocated to uplink signals transmitted from each ONT 28 to the OLT 4, while L-band (e.g. 1565-1625 nm) channels may be allocated to downlink signals from the OLT 4 to the ONT(s) 26 on each branch 26. In such cases, the respective optical combiner/splitters 12,34 in the OLT transceivers 6 and ONTs 28 are commonly provided as passive optical filters well known in the art.

The WDM-PON illustrated in FIG. 1 is known, for example, from “Low Cost WDM PON With Colorless Bidirectional Transceivers”, Shin, D J et al, Journal of Lightwave Technology, Vol. 24, No. 1, January 2006. With this arrangement, each branch 26 is allocated a predetermined pair of wavelength channels, comprising an L-band channel for downlink signals transmitted from the OLT 4 to the branch 26, and a C-band channel for uplink signals transmitted from the ONT(s) 28 of the branch 26 to the OLT 4. The MUX/DEMUX 16 in the OLT 4 couples the selected channels of each branch 26 to a respective one of the transceivers 6. Consequently, each transceiver 6 of the ONT is associated with one of the branches 26, and controls uplink and downlink signalling between the ONT 4 and the ONT(s) 28 of that branch 26. Each transceiver 6 and ONT 28 is rendered “colorless”, by using reflective light sources 8, 32, such as reflective semi-conductor optical amplifiers; injection-locked Fabry-Perot lasers; reflective electro-absorptive modulators; and reflective Mach-Zehnder modulators. With this arrangement, each light source 8, 30 requires a “seed” light which is used to produce the respective downlink/uplink optical signals. In the system of FIG. 1, the seed light for downlink signals is provided by an L-band broadband light source (BLS) 36 via an L-band optical circulator 38. Similarly, the seed light for uplink signals is provided by a C-band broadband light source (BLS) 40 via a C-band optical circulator 42.

WDM-PONs suffer a limitation in that they are designed around a one-to-one connection paradigm. That is, each transceiver 6 of the OLT 4 communicates with the ONT(s) 28 of only one branch 26. However, it is desirable to also be able to broadcast analog signals to all of the ONT(s) 28. For example, it would be desirable to be able broadcast analog RF/video signals to subscribers through the WDM-PON infrastructure. Furthermore, it would be desirable to be able to provide this capability without requiring active components within the network.

### SUMMARY OF THE INVENTION

An aspect of the present invention provides, in a Wavelength Division Multiplexed Passive Optical Network (WDM-PON) including, a system for distributing uplink, downlink and RF/Video broadcast signalling. An Array Waveguide Grating (AWG) couples respective wavelength channels between a trunk fibre of the WDM-PON and a plurality of branch fibers of the WDM-PON. The AWG has a predetermined free spectral range and implements a channel plan comprising at least three spectral segments, each segment having a width equal to the free spectral range of the AWG. An Optical Line Terminal of the WDM-PON receives wavelength division multiplexed uplink signals within a first one of the spectral segments, and transmits wavelength division multiplexed downlink signals within a second one of the spectral segments. Respective channel plans within the first and second spectral segments are identical. An RF/Video broadcast transmitter generates an RF/Video broadcast signal within a third one of the spectral segments.

For the purposes of the present application, respective channel plans of any two spectral segments are considered to be identical if, for every channel “A” in one segment, there is a corresponding channel “B” in the other segment, and the two channels “A” and “B” are separated by an integer multiple of the free spectral range of the AWG.

### BRIEF DESCRIPTION OF THE DRAWINGS

Further features and advantages of the present invention will become apparent from the following detailed description, taken in combination with the appended drawings, in which:

FIG. 1 schematically illustrates a conventional WDM-PON known in the prior art;

FIG. 2 schematically illustrates a WDM-PON with RF distribution in accordance with a representative embodiment of the present invention;

FIG. 3 schematically illustrates a representative channel plan usable in the WDM-PON of FIG. 2;

FIGS. 4a-4c schematically illustrate respective embodiments of an RF transmitter usable in the WDM-PON of FIG. 2; and

FIG. 5 schematically illustrates a second representative channel plan usable in the WDM-PON of FIG. 2 and using the RF transmitter of FIG. 4c.

It will be noted that throughout the appended drawings, like features are identified by like reference numerals.

### DETAILED DESCRIPTION OF PREFERRED EMBODIMENTS

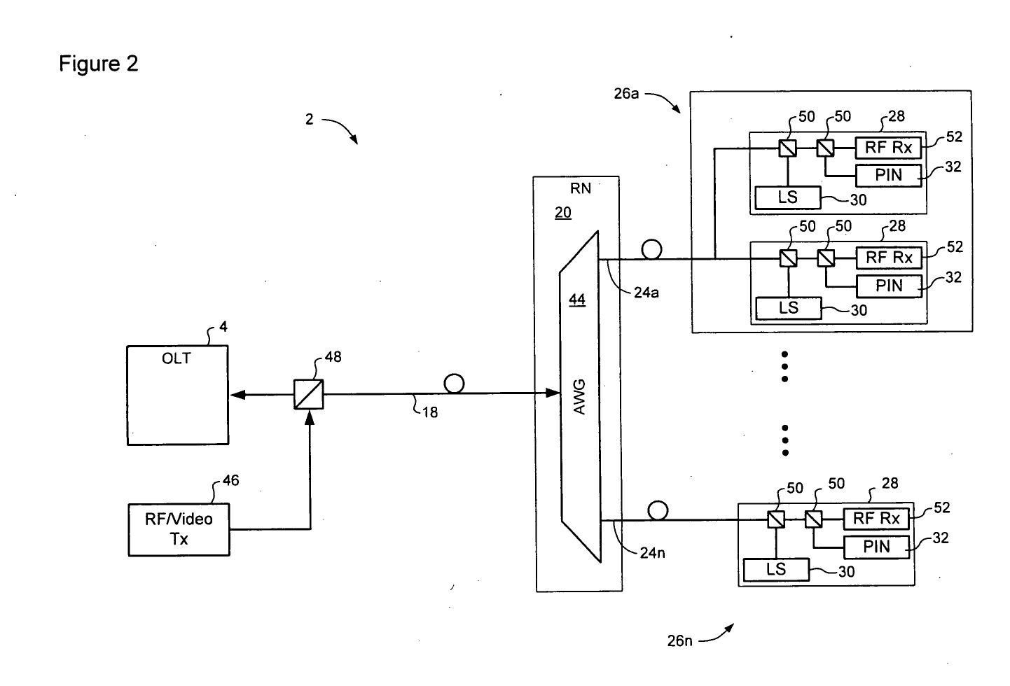

The present invention provides techniques for overlaying RF-Video broadcast signalling on a Wavelength Division Multiplexing Passive Optical Network (WDM-PON). A representative embodiment is described below with reference to FIGS. 2-5.

As is known in the art, an Array-Waveguide Grating (AWG) is capable of demultiplexing a plurality of wavelength channels from Wavelength Division Multiplexed (WDM) signal received through a WDM trunk fibre, and outputting each demultiplexed wavelength channel though a respective one of a plurality of branch fibres. An AWG also performs the reciprocal operation, so that channel signals received through the branch fibers are multiplexed into a WDM signal launched through the trunk fibre.

As is known in the art, within the free spectral range (FSR) of the AWG there is a unique relationship between channel wavelength and each branch fibre. That is, a given optical channel (typically encompassing a narrow band of wavelengths) will be coupled between the trunk fibre 18 and a unique one of the branch ports 24. It is also known that an AWG is cyclic, with a periodicity that corresponds with the FSR. Consequently, an AWG will actually operate to couple a plurality of optical channels between the trunk fibre 18 and a unique one of the branch ports 24. Consequently, each branch port 24 will receive a unique set of wavelength channels, which are separated from each other by the free spectral range of the AWG. For example, consider an AWG with a FSR of 30 nm. In such an AWG, the wavelength channels coupled to each branch 24 will be spectrally distributed at intervals of 30 nm.

In very general terms, the present invention exploits the above-described cyclic characteristic of the AWG to facilitate proper distribution of uplink, downlink and broadcast channels to each branch 26 of a WDM-PON. In the illustrated embodiments, this is implemented by designing the WDM channel plan in accordance with the FSR of the AWG. Referring to FIGS. 2-6, a representative WDM-PON utilizing AWG distribution is schematically illustrated.

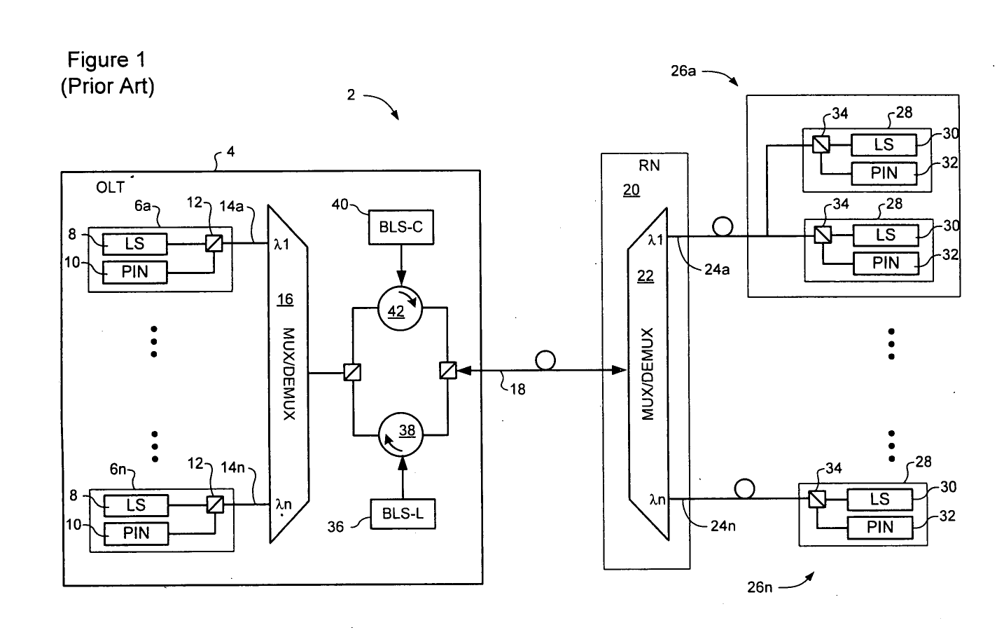

As may be seen in FIG. 2, WDM-PON using AWG distribution may be topologically similar to that of a conventional WDM-PON, such as the WDM-PON described above with reference to FIG. 1. More particularly, a generally conventional OLT 4 may be used, and thus will not be described in further detail. At the remote node 20, an Array-Waveguide Grating (AWG) 44 is used for coupling wavelength channels between the trunk fibre 18 and each branch 26 of the WDM-PON. A broadband RF/Video transmitter 46 is provided for generating an RF/video signal for broadcast to each of the ONTs 28. A broadband optical coupler 48 of a type known in the art can be used to couple the RF/video signal from the RF/Video transmitter 46 into the trunk fibre 18. At each ONT 28, one or more filters 50 can be used to separate the three wavelength channels, which can then be coupled to a light source 30, detector 32 and RF receiver 52, as appropriate. In some embodiments, a conventional triplexer known in the art may be used at each ONT 28 for this purpose.

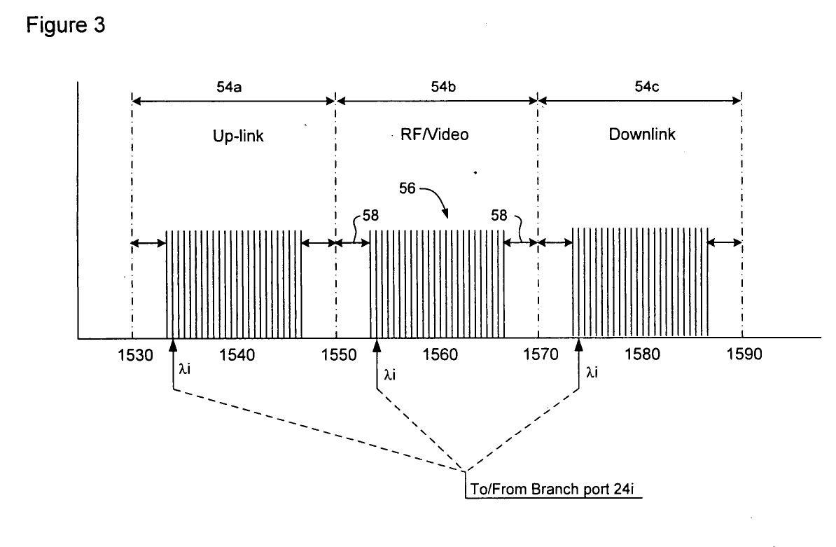

As noted above, the channel plan of the WDM signal in the trunk fibre 18 is selected to exploit the inherent periodicity of the AWG 44, such that corresponding channels of the up-link, downlink and analog RF/Video signals are properly coupled between the fibre trunk 18 and each branch 26 of the WDM-PON. FIG. 3 schematically illustrates one possible channel plan, for the case of an AWG having a free spectral range (FSR) of 20 nm.

In the embodiment of FIG. 3, the channel plan comprises a continuous spectral range (of 60 nm width) which is divided into three segments 54, each segment having a width equal to the FSR of the AWG (in this case, 20 nm). As may be seen in FIG. 3, the arrangement of optical channels within each segment is identical. For example, the optical channels may be arranged in accordance with a segment channel plan comprising a WDM video signal 56 having a plurality of optical wavelength channels evenly spaced about the center of the segment, and bounded by a pair of dead-zones 58. Typically, the number and spacing of wavelength channels within each segment 54 will be determined by the optical design of the AWG. Similarly, the optimum width of the dead-zones 58 will be determined by the optical design of the AWG. Dividing the spectrum in the manner described above means that the AWG 44 will operate to uniquely couple a corresponding one wavelength channel (λi, where i is a channel index within each segment) from each segment 54 between the trunk fibre 18 and a unique one of the branch ports 24i. By allocating each segment 54 to one of uplink signals, downlink signals, and RF/Video broadcast, as shown in FIG. 3, the desired distribution of signalling traffic within the WDM-PON can be obtained.

FIG. 3 illustrates one possible allocation of segments 54, in which a “lower” segment 54a (e.g. 1530-1550 nm) is allocated to uplink signals, a middle segment 54b (e.g. 1550-1570 nm) is allocated to RF/Video broadcast, and an “upper” segment 54c (e.g. 1570-1590 nm) is allocated to downlink signals. This arrangement roughly follows the C-Band and L-band channel plans used in conventional WDM-PONS, and thus may simplify selection of optical components for a particular WDM-PON. However, it will be clear that the specific segments to which uplink signals, downlink signals, and RF/Video broadcast are allocated is not material to the present invention.

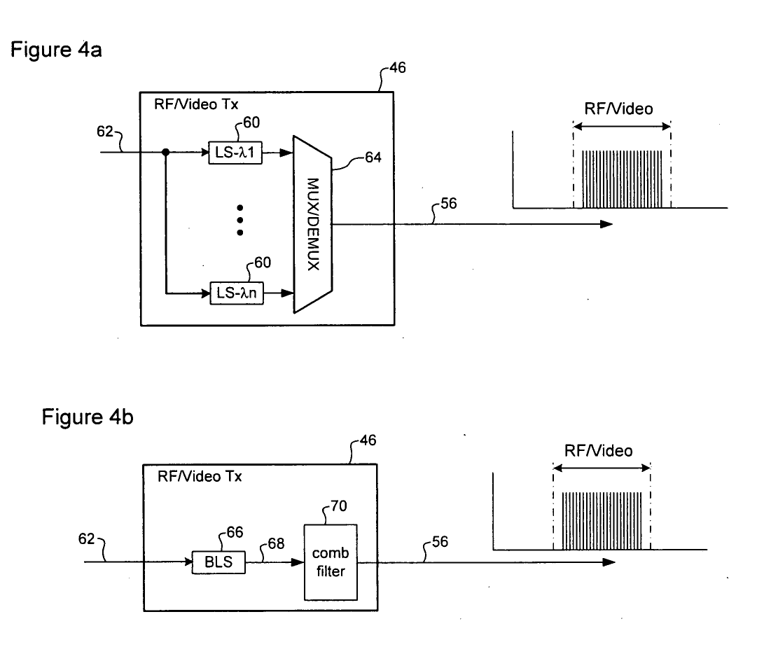

FIG. 4a illustrates a representative embodiment of the RF/Video Transmitter 46, in which a set of narrow-band lasers 60 are modulated using a common input RF video signal 62 to generate respective narrow band RF/Video channel signals, each of which is tuned to the center wavelength of a respective channel of the RF/Video segment 54b. A multiplexer 64 combines the narrow-band RF/Video signals to into the WDM RF/Video signal 56, which is then distributed through the WDM-PON to the ONTs 26. If desired, each of the narrow-band lasers 60 may be provided as conventional bulk semiconductor laser diodes driven in accordance with the electronic RF/video signal 62 to be transmitted. In the embodiment of FIG. 4b, a single broadband light source 66 is used to generate a broadband optical RF/Video signal 68, which is then filtered using a comb filter 70 to form a WDM RF/Video signal 56 having the desired channel plan. The broadband light source 66 may be provided as a Light-Emitting Diode (LED), which provides a low cost solution for generating the broadband optical RF/Video signal 68.

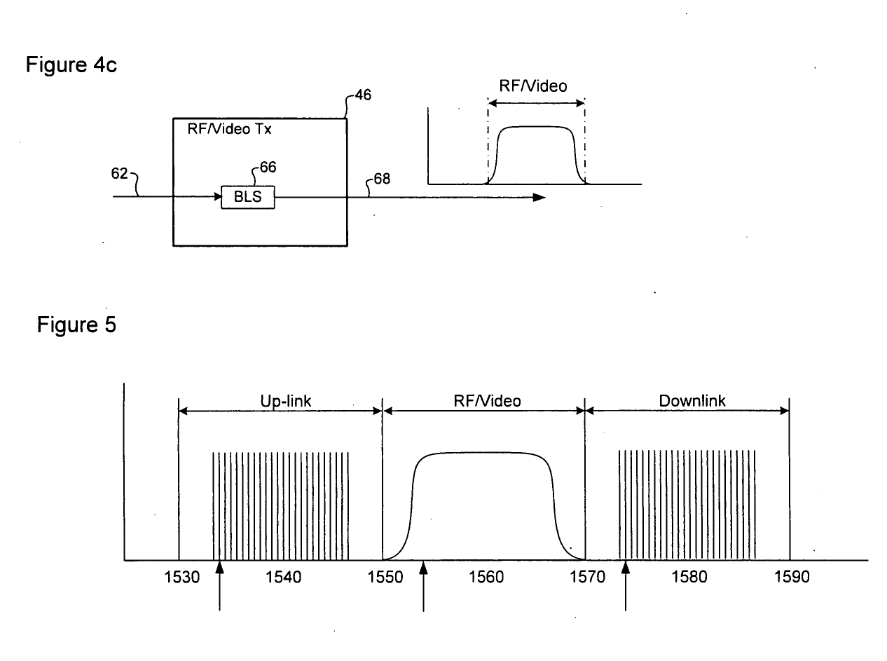

FIG. 4c illustrates a still further alternative RF/Video transmitter 46, in which a single broadband light source 66 is used to generate a broadband optical RF/Video signal 68, which is then conveyed through the trunk fibre 18 to the AWG 44. In this case, the channel plan of the WDM-PON corresponds with that illustrated in FIG. 5. Thus, the up-link and downlink segments 54a and 54c include respective WDM signals 56 arranged in accordance with identical channel plans. The RF/Video segment 54b, on the other hand, encompasses the broadband optical RF/Video signal 68 which preferably has a bandwidth corresponding to the total width of the respective WDM signals 56 in the up-link and downlink segments 54. With this arrangement, the up-link and downlink channels are routed between the trunk fibre 18 and the branch ports 24 as described above. The wavelength-selective routing capability of the AWG 44 effectively filters the broadband optical RF/Video signal 68, so that each branch port 24 receives a respective portion of the broadband optical RF/Video signal 68, centered on the appropriate wavelength for that branch port 24. This embodiment is advantageous in that it avoids the cost of multiple narrowband lasers 60 and multiplexer 64 (in the case of the embodiment of FIG. 4a) or the comb filter 70, in the case of the embodiment of FIG. 4b.

The embodiments of the invention described above are intended to be illustrative only. The scope of the invention is therefore intended to be limited solely by the scope of the appended claims.

We claim:

1. In a Wavelength Division Multiplexed Passive Optical Network (WDM-PON) including, a system for distributing uplink, downlink and RF/Video broadcast signalling, the system comprising:
an Array Waveguide Grating (AWG) for coupling respective wavelength channels between a trunk fibre of the WDM-PON and a plurality of branch fibers of the WDM-PON, the AWG having a predetermined free spectral range and implementing a channel plan comprising at least three spectral segments, each segment having a width equal to the free spectral range of the AWG;
an Optical Line Terminal of the WDM-PON, the Optical Line Terminal receiving wavelength division multiplexed uplink signals within a first one of the spectral segments, and transmitting wavelength division multiplexed downlink signals within a second one of the spectral segments, wherein respective channel plans within the first and second spectral segments are identical; and
an RF/Video broadcast transmitter for generating an RF/Video broadcast signal within a third one of the spectral segments.

2. The system as claimed in claim 1, wherein the RF/Video broadcast transmitter generates the RF/Video broadcast signal as a wavelength division multiplexed signal having a channel plan identical to that of the first and second spectral segments.

3. The system as claimed in claim 1, wherein the RF/Video broadcast transmitter generates the RF/Video broadcast signal as broadband signal having a bandwidth corresponding to the respective channel plans of the first and second spectral segments.
